(19) United States
(12) Patent Application Publication
(10) Pub. No.: US 2024/0257104 A1
(43) Pub. Date: Aug. 1, 2024

(54) NON-FUNGIBLE TOKEN GENERATING SYSTEM, METHOD, AND NON-TRANSITORY COMPUTER READABLE STORAGE MEDIUM THEREOF

(71) Applicant: HTC Corporation, Taoyuan City (TW)

(72) Inventor: Kuan-Wei LI, Taoyuan City (TW)

(21) Appl. No.: 18/163,256

(22) Filed: Feb. 1, 2023

(51) Int. Cl. G06Q 20/36; G06Q 20/38; G06Q 20/40

(52) U.S. Cl. CPC G06Q 20/3672; G06Q 20/3678; G06Q 20/389; G06Q 20/40145

(57) ABSTRACT

A non-fungible token generating system, method, and non-transitory computer readable storage medium thereof are provided. The system determines whether a control signal corresponds to a non-fungible token generating operation or a multimedia data generating operation. In response to the control signal corresponding to the non-fungible token generating operation, the system generates a first multimedia data through an image capturing device, and the system uploads the first multimedia data and an operator identity information to a blockchain to generate a non-fungible token corresponding to the first multimedia data based on a smart contract deployed on the blockchain. In response to the control signal corresponding to the multimedia data generating operation, the system generates a second multimedia data through the image capturing device.

### BACKGROUND

### Field of Invention

The present invention relates to a non-fungible token generating system, method, and non-transitory computer readable storage medium thereof. More particularly, the present invention relates to a system, method and non-transitory computer-readable recording medium thereof for efficiently generating a non-fungible token.

### Description of Related Art

In recent years, various blockchain-related technologies have developed rapidly, and various related technologies and applications have been proposed one after another.

In the prior art, users can make the creation of digital data (e.g., images, videos, etc.) into non-fungible tokens (NFT) through the authentication mechanism on the blockchain.

However, converting the digital data into corresponding non-fungible tokens needs to perform relevant identity authentication and complicated data application. Therefore, a user is not easy for users to convert the creation of digital data into corresponding non-fungible tokens, causing a bad user experience of the users.

Accordingly, there is an urgent need for a non-fungible token generating technology that can efficiently provide a user with a method for efficiently generating a non-fungible token.

### SUMMARY

An objective of the present disclosure is to provide a non-fungible token generating system. The non-fungible token generating system comprises at least one electronic device. The at least one electronic device determines whether a control signal corresponds to a non-fungible token generating operation or a multimedia data generating operation. The at least one electronic device executes the non-fungible token generating operation in response to the control signal corresponding to the non-fungible token generating operation, wherein the non-fungible token generating operation comprises: generating a first multimedia data through an image capturing device; and uploading, based on a smart contract deployed on a blockchain, the first multimedia data and an operator identity information to the blockchain to generate a non-fungible token corresponding to the first multimedia data, wherein the non-fungible token is stored in a first user account corresponding to the blockchain. The at least one electronic device executes the multimedia data generating operation in response to the control signal corresponding to the multimedia data generating operation, wherein the multimedia data generating operation comprises: generating a second multimedia data through the image capturing device; and storing the second multimedia data in the at least one electronic device.

Another objective of the present disclosure is to provide a non-fungible token generating method, which is adapted for use in at least one electronic device. The non-fungible token generating method comprises following steps: determining whether a control signal corresponds to a non-fungible token generating operation or a multimedia data generating operation; executing the non-fungible token generating operation in response to the control signal corresponding to the non-fungible token generating operation, wherein the non-fungible token generating operation comprises: generating a first multimedia data through an image capturing device; and uploading, based on a smart contract deployed on a blockchain, the first multimedia data and an operator identity information to the blockchain to generate a non-fungible token corresponding to the first multimedia data, wherein the non-fungible token is stored in a first user account corresponding to the blockchain; executing the multimedia data generating operation in response to the control signal corresponding to the multimedia data generating operation, wherein the multimedia data generating operation comprises: generating a second multimedia data through the image capturing device; and storing the second multimedia data in the at least one electronic device.

A further objective of the present disclosure is to provide a non-transitory computer readable storage medium having a computer program stored therein. The computer program comprises a plurality of codes, the computer program executes a non-fungible token generating method after being loaded into at least one electronic device. The non-fungible token generating method comprises following steps: determining whether a control signal corresponds to a non-fungible token generating operation or a multimedia data generating operation; executing the non-fungible token generating operation in response to the control signal corresponding to the non-fungible token generating operation, wherein the non-fungible token generating operation comprises: generating a first multimedia data through an image capturing device; and uploading, based on a smart contract deployed on a blockchain, the first multimedia data and an operator identity information to the blockchain to generate a non-fungible token corresponding to the first multimedia data, wherein the non-fungible token is stored in a first user account corresponding to the blockchain; executing the multimedia data generating operation in response to the control signal corresponding to the multimedia data generating operation, wherein the multimedia data generating operation comprises: generating a second multimedia data through the image capturing device; and storing the second multimedia data in the at least one electronic device.

According to the above descriptions, the non-fungible token generating technology (at least including the system, the method, and the non-transitory computer readable storage medium) provided by the present disclosure may generate a multimedia data and verify the identity of the operator through various sensing methods, and upload, based on a smart contract deployed in a blockchain, the multimedia data and the operator identity information to the blockchain to generate a non-fungible token corresponding to the multimedia data. The non-fungible token generating technology provided by the present disclosure can quickly and efficiently generate the non-fungible token corresponding to multimedia data. Therefore, the present disclosure solves the disadvantages of the conventional technology that may cause bad user experience.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1A is a schematic diagram depicting a non-fungible token generating system of some embodiments;

FIG. 1B is a schematic diagram depicting a non-fungible token generating system of some embodiments;

FIG. 1C is a schematic diagram depicting a non-fungible token generating system of some embodiments;

FIG. 2 is a schematic diagram depicting the structure of a mobile device and a head-mounted display of some embodiments;

FIG. 3 is a schematic diagram depicting the structure of a wearable device and a handheld controller of some embodiments;

FIG. 4 is a schematic diagram depicting a mobile device of some embodiments; and

FIG. 5 is a partial flowchart depicting the non-fungible token generating method of the third embodiment.

### DETAILED DESCRIPTION

In the following description, a non-fungible token generating system, method, and non-transitory computer readable storage medium thereof according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

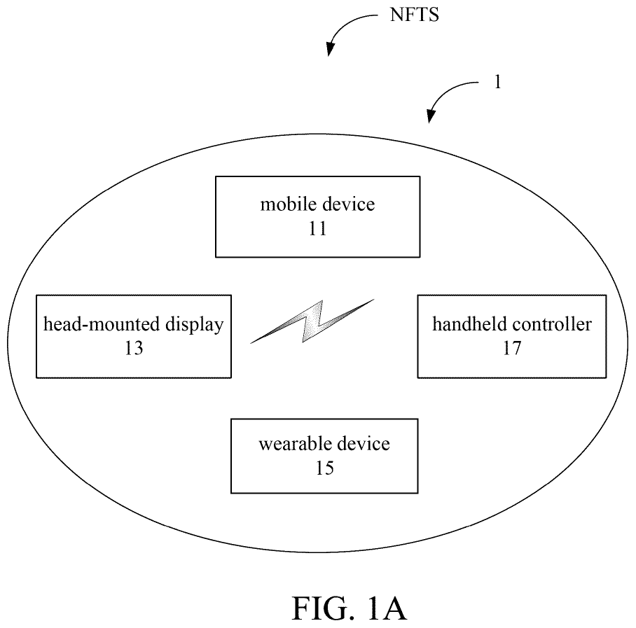

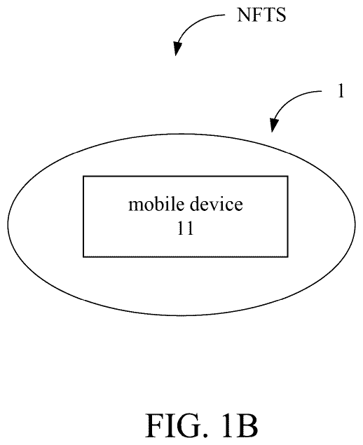

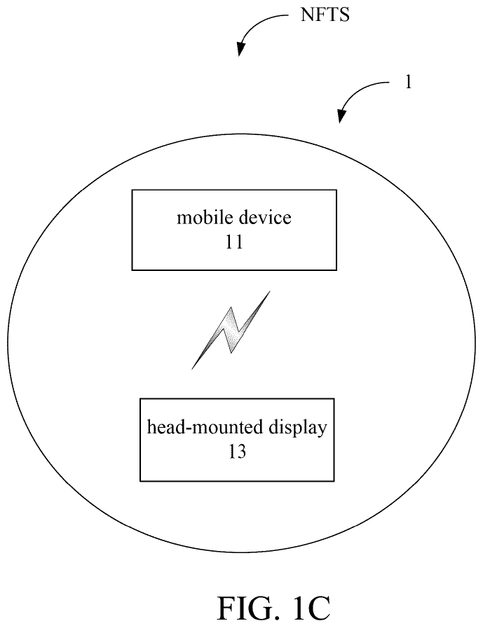

The non-fungible token generating system NFTS in various embodiments of the present disclosure is schematically depicted in FIGS. 1A-1C. In the present disclosure, the non-fungible token generating system NFTS comprises the at least one electronic device 1. Users can quickly produce (i.e., mint) multimedia data (e.g., an image, a video) into a corresponding non-fungible token through the non-fungible token generating system NFTS.

It shall be appreciated that in the present disclosure, the non-fungible token generating system NFTS may use different numbers of electronic devices to collectively execute operations according to different applications (e.g., operations are executed by a single electronic device or operations are collectively executed by a plurality of electronic devices). When the number of electronic devices in the at least one electronic device 1 is greater than 1, the electronic devices in the at least one electronic device 1 have a communication connection between them.

In the present disclosure, as shown in FIG. 1A, the at least one electronic device 1 in the non-fungible token generating system NFTS comprises at least one of a mobile device 11, a head-mounted display 13, a wearable device 15, and a handheld controller 17, or a combination thereof (e.g., two electronic devices, three electronic devices, or four electronic devices).

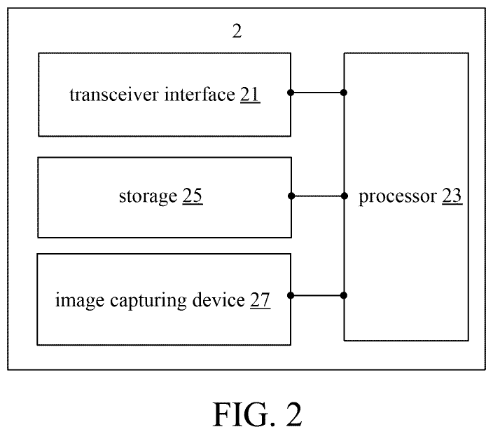

In the present embodiment, a schematic diagram of the structure of the mobile device 11 and the head-mounted display 13 are depicted in FIG. 2. The mobile device 11 and the head-mounted display 13 comprise a transceiver interface 21, a processor 23, and a storage 25. The processor 23 is coupled to the transceiver interface 21 and the storage 25. In some embodiments, as shown in FIG. 2, the mobile device 11 and the head-mounted display 13 may further comprise an image capturing device 27, and the image capturing device 27 is coupled to the processor 23. The image capturing device 27 may comprise a plurality of image capturing units (e.g., a plurality of camera lenses) for capturing a plurality of real-time images corresponding to a field of view (FOV).

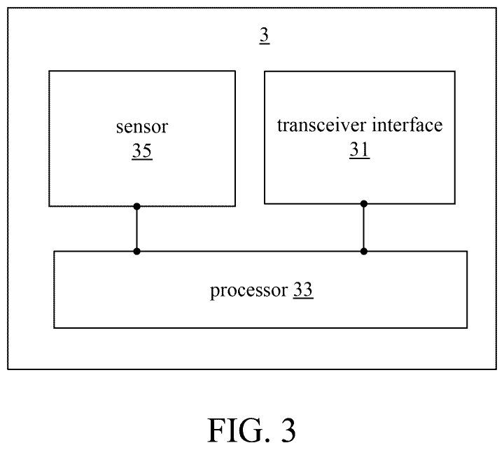

In addition, in the present embodiment, a schematic diagram of the structure of the wearable device 15 and the handheld controller 17 are depicted in FIG. 3. The wearable device 15 and the handheld controller 17 comprise a transceiver interface 31, a processor 33, and a sensor 35. The processor 33 is coupled to the transceiver interface 31 and the sensor 35. The sensor 35 can be any sensing device that can be used to identify an identity, for example, a sensor for identifying fingerprints, a sensor for identifying biological information, and so on.

It shall be appreciated that the transceiver interface 21 and the transceiver interface 31 is an interface capable of receiving and transmitting data or other interfaces capable of receiving and transmitting data and known to those of ordinary skill in the art. The transceiver interface can receive data from sources such as external apparatuses, external web pages, external applications, and so on. The processor 23 and the processor 33 may be any of various processors, Central Processing Units (CPUs), microprocessors, digital signal processors or other computing apparatuses known to those of ordinary skill in the art. The storage 25 may be a memory, a Universal Serial Bus (USB) disk, a hard disk, a Compact Disk (CD), a mobile disk, or any other storage medium or circuit known to those of ordinary skill in the art and having the same functionality.

In some embodiments, the mobile device 11 and the head-mounted display 13 may also comprise a sensor (not shown) electrically connected to the processor 23. For example, the mobile device 11 and the head-mounted display 13 may comprise sensors for recognizing fingerprints (e.g., optical sensors, capacitive sensors, etc.) or sensors for recognizing faces (e.g., iris recognition camera, depth camera, etc.). It shall be appreciated that, in some embodiments, the functions of fingerprint recognition and face recognition can also be implemented by software (e.g., recognizing images obtained by the image capturing device 27).

It shall be appreciated that the sensor can be used to generate sensing data corresponding to a detection target. The sensor can be activated based on different commands or states (e.g., touching a virtual or physical button on the electronic device, or starting a recognition operation based on a user gesture). For example, the sensing data may comprise at least one of a fingerprint sensing data, a face recognition data, and a biometric data, or a combination thereof.

The first embodiment of the present disclosure will be described below. In the first embodiment of the present disclosure, the operation may be executed by an electronic device having a computing function among the at least one electronic device 1.

For ease of understanding, as shown in FIG. 1B, the following will take the mobile device 11 executing the operations as an example for illustration. In some embodiments, the operations may also be executed by other electronic devices independently (e.g., the head-mounted display 13). Those skilled in the art should be able to understand the execution methods of different electronic devices based on the following content, so no further details are given.

In the present embodiment, the mobile device 11 receives a control signal, and the control signal is configured to instruct the operation selected by the user. Next, the mobile device 11 determines whether a control signal corresponds to a non-fungible token generating operation (i.e., minting the multimedia data into the non-fungible token) or a multimedia data generating operation (i.e., generating the general multimedia data).

In the present embodiment, in response to the control signal corresponding to the non-fungible token generating operation, the mobile device 11 may execute the non-fungible token generating operation.

Specifically, the non-fungible token generating operation comprises: the mobile device 11 generates a first multimedia data (e.g., an image or a video) through an image capture device (e.g., the image capturing device 27). Next, the mobile device 11 uploads, based on a smart contract deployed on a blockchain, the first multimedia data and an operator identity information to the blockchain to generate a non-fungible token corresponding to the first multimedia data, wherein the non-fungible token is stored in a first user account corresponding to the blockchain.

It shall be appreciated that the mobile device 11 may execute operations related to uploading the blockchain through a public smart contract deployed on the blockchain (e.g., a public blockchain) or through a self-defined smart contract pre-deployed on the blockchain. Those of ordinary skill in the art should be able to appreciate the relevant deployment and operation of smart contracts based on the above description, so details will not be repeated here.

In the present embodiment, in response to the control signal corresponding to the multimedia data generating operation, the mobile device 11 may execute the multimedia data generating operation.

Specifically, the multimedia data generating operation comprises: the mobile device 11 generates a second multimedia data through the image capturing device. Next, the mobile device 11 stores the second multimedia data in the mobile device 11.

In some embodiments, the non-fungible token corresponding to the first multimedia data comprises a metadata corresponding to the first multimedia data.

For example, the metadata corresponding to the first multimedia data may be generated by the following operations: the mobile device 11 generates a contract address and a token identification (Token ID) of the metadata based on the smart contract deployed on the blockchain corresponding to the first user account.

It shall be appreciated that the metadata corresponding to the first multimedia data may comprise other necessary information. For example, the metadata corresponding to the first multimedia data may comprise a creator information, a creation time, a storage address, a blockchain address, a token status, etc.

In some embodiments, the first user account is associated with the operator identity information (i.e., corresponding to the same identity information).

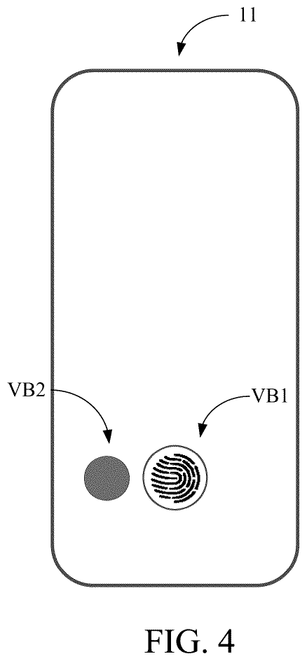

For ease of understanding, please refer to FIG. 4. FIG. 4 illustrates a schematic diagram of a mobile device 11 with a fingerprint recognition function. As shown in FIG. 4, the mobile device 11 may comprise a general button VB2 for starting image shooting and a button VB1 for generating a non-fungible token, and the button VB1 has a fingerprint recognition function. It shall be appreciated that the buttons VB1 and VB2 on the mobile device 11 may be physical buttons or virtual buttons (e.g., displayed on the screen).

In the present example, the user may choose to touch the button VB1 on the mobile device 11 (i.e., the button corresponds to execute the non-fungible token generating operation after shooting) or the button VB2 (i.e., the button corresponds the general shooting operation) to start the image capturing operation.

In the present example, since the button VB1 also has the function of fingerprint recognition to verify the identity of the user, when the user presses the button VB1, it means that the user has agreed to perform the relevant blockchain uploading operation (i.e., including the operations of logging into the relevant user account and agreeing to pay the relevant fees). Therefore, the mobile device 11 may generate a control signal corresponding to the non-fungible token generating operation and execute the non-fungible token generating operation to make the multimedia data generated by the corresponding button VB1 into the non-fungible token, and the mobile device 11 may store the non-fungible token in the user account corresponding to the blockchain.

In addition, in the present example, when the user presses the button VB2, the mobile device 11 may generate a control signal corresponding to the multimedia data generating operation (i.e., a control signal for generally shooting images), and execute the multimedia data generating operation.

It shall be appreciated that FIG. 4 is only used to illustrate an embodiment of identity verification (i.e., fingerprint recognition) disclosed in the present disclosure. In other embodiments, the non-fungible token generating system NFTS can also be verified in different ways and execute similar operations. For example, an image can be captured by the lens of the electronic device for identity verification. In addition, the present disclosure is not limited to the user operating a button to execute an operation. For example, a user may make a gesture to select a non-fungible token generating operation or a multimedia data generating operation, and the electronic device is driven to execute the corresponding operation according to the gesture.

In some embodiments, the mobile device 11 may store a list of a plurality of users that are allowed to operate. The mobile device 11 may verify the identity of the operator through various verification methods, and the verified users may generate the multimedia data as the non-fungible token through mobile devices 11. In some embodiment, the operator identity may be different from the user account used for payment.

Specifically, the non-fungible token generating operation further comprises the following operations: the mobile device 11 determines whether the operator identity information conforms to an allowed operator list corresponding to the at least one electronic device based on a sensing data, wherein the sensing data is generated by a sensor in the mobile device 11. Next, the mobile device 11 uploads, based on the smart contract deployed on the blockchain, the first multimedia data and an operator identity information to the blockchain to generate the non-fungible token corresponding to the first multimedia data in response to the operator identity information conforming to the allowed operator list.

In some embodiments, since the mobile device 11 has verified the operator's identity and obtained the operator's payment agreement, the mobile device 11 may directly carry out the payment for uploading the blockchain operation through the corresponding user account, so as to quickly execute the operation of the blockchain uploading to generate the non-fungible token corresponding to the first multimedia data.

In some embodiments, the mobile device 11 may further execute a payment operation through a cryptocurrency wallet of a user account (e.g., corresponding to the first user account or a different user account), so as to pay the uploading fee corresponding to the blockchain.

Specifically, the mobile device 11 executes a payment operation to pay an uploading fee corresponding to the blockchain based on a cryptocurrency wallet corresponding to a second user account. Next, the mobile device 11 uploads, based on the smart contract deployed on the blockchain, the first multimedia data and the operator identity information to the blockchain to generate the non-fungible token corresponding to the first multimedia data in response to executing the payment operation. In some embodiments, the second user account is different from the first user account.

Next, the specific operation of the second embodiment of the present disclosure will be described in detail below. In short, in addition to the operations executed in the first embodiment, in the second embodiment of the present disclosure, two electronic devices in the at least one electronic device 1 may collectively execute operations.

For ease of understanding, as shown in FIG. 1C, the following takes the mobile device 11 and the head-mounted display 13 to collectively execute the operations as an example. Since some of the operations are similar, the following will only describe the different operations.

It shall be appreciated that, in some embodiments, the operations can also be executed collectively by other electronic devices (e.g., collectively executed by the mobile device 11 and the wearable device 15, or collectively executed by the head-mounted display 13 and the handheld controller 17). Those skilled in the art should be able to understand the execution methods of different electronic devices based on the following contents, so no further details are given here.

In the present embodiment, the non-fungible token generating operation and the multimedia data generating operation are executed by a first electronic device of the at least one electronic device (e.g., mobile device 11), and the first electronic device and a second electronic device of the at least one electronic device (e.g., the head-mounted display 13) have a communication connection.

In the present embodiment, the control signal is generated by the second electronic device of the at least one electronic device (e.g., the head-mounted display 13). For example, the head-mounted display 13 may analyze the user's gestures to generate corresponding control signals.

In some embodiments, the sensor is arranged in a second electronic device of the at least one electronic device (e.g., the head-mounted display 13), the non-fungible token generating operation and the multimedia data generating operation are executed by a first electronic device of the at least one electronic device (e.g., the mobile device 11), and the first electronic device has a communication connection with the second electronic device.

In some embodiments, the second electronic device can be the mobile device 11, the head-mounted display 13, the handheld controller 17, or the wearable device 15.

For example, the sensing data can be obtained through the sensor (e.g., iris recognition camera) in the head-mounted display 13, and the head-mounted display 13 determines whether the operator identity information conforms to an allowed operator list corresponding to the at least one electronic device 1. For another example, the sensing data can be obtained through the sensor (e.g., biometric sensor) in the wearable device 15, and the wearable device 15 determines whether the operator identity information conforms to an allowed operator list corresponding to the at least one electronic device 1.

In some embodiments, the at least one electronic device 1 may comprise an electronic device with a sensing function and an electronic device with a computing function to operate together. For example, the sensing data can be obtained by an electronic device with a sensor, and then the non-fungible token generating operation can be executed by an electronic device with a computing function.

In some embodiments, the electronic device that executes the non-fungible token generating operation and the multimedia data generating operation and the electronic device that generates the control signal may be different electronic devices. For example, the user may use the handheld controller 17 to generate a control signal (e.g., a button on the handheld controller 17), and the head-mounted display 13 executes the non-fungible token generating operation and the multimedia data generating operation after receiving the control signal.

It shall be appreciated that the operations of the first embodiment and the second embodiment of the present disclosure can also be executed collectively by more than two electronic devices (e.g., the computing operation is executed by the mobile device 11, and the identity verification operation is executed by the head-mounted display 13 and the wearable device 15). Those skilled in the art should be able to understand the implements in which a plurality of electronic devices collectively execute the operations based on the foregoing descriptions, so further details are omitted.

According to the above descriptions, the non-fungible token generating system NFTS provided by the present disclosure may generate a multimedia data and verify the identity of the operator through various sensing methods, and upload, based on a smart contract deployed in a blockchain, the multimedia data and the operator identity information to the blockchain to generate a non-fungible token corresponding to the multimedia data. The non-fungible token generating technology provided by the present disclosure can quickly and efficiently generate the non-fungible token corresponding to multimedia data. Therefore, the present disclosure solves the disadvantages of the conventional technology that may cause bad user experience.

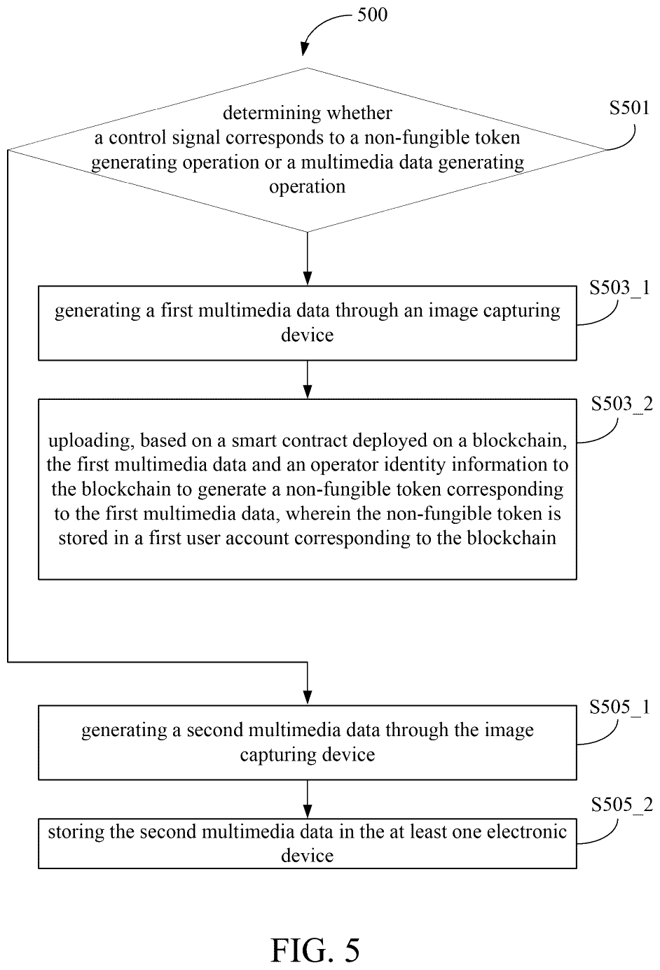

A third embodiment of the present disclosure is a non-fungible token generating method and a flowchart thereof is depicted in FIG. 5. The non-fungible token generating method 500 is adapted for use in at least one electronic device (e.g., the at least one electronic device 1 in the non-fungible token generation system NFTS described in the first embodiment). The non-fungible token generating method 500 executes the non-fungible token generating operation or the multimedia data generating operation through the steps S501 to S505.

First, in the step S501, the at least one electronic device determines whether a control signal corresponds to a non-fungible token generating operation or a multimedia data generating operation.

Next, in the step S503, the at least one electronic device executes the non-fungible token generating operation in response to the control signal corresponding to the non-fungible token generating operation. The non-fungible token generating operation comprises the steps S503_1 and S503_2. In the step S503_1, the at least one electronic device generates a first multimedia data through an image capturing device. Next, in the step S503_2, the at least one electronic device uploads, based on a smart contract deployed on a blockchain, the first multimedia data and an operator identity information to the blockchain to generate a non-fungible token corresponding to the first multimedia data, wherein the non-fungible token is stored in a first user account corresponding to the blockchain.

In addition, the at least one electronic device executes the multimedia data generating operation in response to the control signal corresponding to the multimedia data generating operation. The multimedia data generating operation comprises the steps S505_1 and S505_2. In the step S505_1, the at least one electronic device generates a second multimedia data through the image capturing device. Next, in the step S505_2, the at least one electronic device stores the second multimedia data in the at least one electronic device.

In some embodiments, the non-fungible token generating operation further comprises following steps: executing a payment operation to pay an uploading fee corresponding to the blockchain based on a cryptocurrency wallet corresponding to a second user account; and uploading, based on the smart contract deployed on the blockchain, the first multimedia data and the operator identity information to the blockchain to generate the non-fungible token corresponding to the first multimedia data in response to executing the payment operation.

In some embodiments, the non-fungible token generating operation and the multimedia data generating operation are executed by a first electronic device of the at least one electronic device, and the first electronic device and a second electronic device of the at least one electronic device have a communication connection.

In some embodiments, the control signal is generated by the second electronic device of the at least one electronic device.

In some embodiments, the non-fungible token corresponding to the first multimedia data comprises a metadata corresponding to the first multimedia data.

In some embodiments, the metadata corresponding to the first multimedia data is generated by following steps: generating a contract address and a token identification of the metadata based on the smart contract deployed on the blockchain corresponding to the first user account.

In some embodiments, the non-fungible token generating operation further comprises following steps: determining whether the operator identity information conforms to an allowed operator list corresponding to the at least one electronic device based on a sensing data, wherein the sensing data is generated by a sensor in the at least one electronic device; and uploading, based on the smart contract deployed on the blockchain, the first multimedia data and an operator identity information to the blockchain to generate the non-fungible token corresponding to the first multimedia data in response to the operator identity information conforming to the allowed operator list.

In some embodiments, the sensing data comprises at least one of a fingerprint sensing data, a face recognition data, and a biometric data, or a combination thereof.

In some embodiments, the sensor is arranged in a second electronic device of the at least one electronic device, the non-fungible token generating operation and the multimedia data generating operation are executed by a first electronic device of the at least one electronic device, and the first electronic device has a communication connection with the second electronic device.

In addition to the aforesaid steps, the third embodiment can also execute all the operations and steps of the non-fungible token generating system NFTS set forth in the first embodiment and the second embodiment, have the same functions, and deliver the same technical effects as the first embodiment and the second embodiment. How the third embodiment executes these operations and steps, has the same functions, and delivers the same technical effects will be readily appreciated by those of ordinary skill in the art based on the explanation of the first embodiment and the second embodiment. Therefore, the details will not be repeated herein.

The non-fungible token generating method described in the third embodiment may be implemented by a computer program having a plurality of codes. The computer program may be a file that can be transmitted over the network, or may be stored into a non-transitory computer readable storage medium. After the codes of the computer program are loaded into at least one electronic device (e.g., the at least one electronic device 1 in the non-fungible token generation system NFTS), the computer program executes the non-fungible token generating method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

It shall be appreciated that in the specification and the claims of the present disclosure, some words (e.g., the multimedia data, the user account, gesture, and the electronic device) are preceded by terms such as “first” or “second”, and these terms of “first” or “second” are only used to distinguish these different words. For example, the “first” and “second” multimedia data are only used to indicate the multimedia data used in different operations.

According to the above descriptions, the non-fungible token generating technology (at least including the system, the method, and the non-transitory computer readable storage medium) provided by the present disclosure may generate a multimedia data and verify the identity of the operator through various sensing methods, and upload, based on a smart contract deployed in a blockchain, the multimedia data and the operator identity information to the blockchain to generate a non-fungible token corresponding to the multimedia data. The non-fungible token generating technology provided by the present disclosure can quickly and efficiently generate the non-fungible token corresponding to multimedia data. Therefore, the present disclosure solves the disadvantages of the conventional technology that may cause bad user experience.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A non-fungible token generating system, comprising:
at least one electronic device, being configured to execute operations comprising:
determining whether a control signal corresponds to a non-fungible token generating operation or a multimedia data generating operation;
executing the non-fungible token generating operation in response to the control signal corresponding to the non-fungible token generating operation, wherein the non-fungible token generating operation comprises:
generating a first multimedia data through an image capturing device; and
uploading, based on a smart contract deployed on a blockchain, the first multimedia data and an operator identity information to the blockchain to generate a non-fungible token corresponding to the first multimedia data, wherein the non-fungible token is stored in a first user account corresponding to the blockchain;
executing the multimedia data generating operation in response to the control signal corresponding to the multimedia data generating operation, wherein the multimedia data generating operation comprises:
generating a second multimedia data through the image capturing device; and
storing the second multimedia data in the at least one electronic device.

2. The non-fungible token generating system of claim 1, wherein the non-fungible token generating operation further comprises following operations:
executing a payment operation to pay an uploading fee corresponding to the blockchain based on a cryptocurrency wallet corresponding to a second user account; and
uploading, based on the smart contract deployed on the blockchain, the first multimedia data and the operator identity information to the blockchain to generate the non-fungible token corresponding to the first multimedia data in response to executing the payment operation.

3. The non-fungible token generating system of claim 1, wherein the non-fungible token generating operation and the multimedia data generating operation are executed by a first electronic device of the at least one electronic device, and the first electronic device and a second electronic device of the at least one electronic device have a communication connection.

4. The non-fungible token generating system of claim 3, wherein the control signal is generated by the second electronic device of the at least one electronic device.

5. The non-fungible token generating system of claim 1, wherein the non-fungible token corresponding to the first multimedia data comprises a metadata corresponding to the first multimedia data.

6. The non-fungible token generating system of claim 5, wherein the metadata corresponding to the first multimedia data is generated by following operations:
generating a contract address and a token identification of the metadata based on the smart contract deployed on the blockchain corresponding to the first user account.

7. The non-fungible token generating system of claim 1, wherein the non-fungible token generating operation further comprises following operations:
determining whether the operator identity information conforms to an allowed operator list corresponding to the at least one electronic device based on a sensing data, wherein the sensing data is generated by a sensor in the at least one electronic device; and
uploading, based on the smart contract deployed on the blockchain, the first multimedia data and an operator identity information to the blockchain to generate the non-fungible token corresponding to the first multimedia data in response to the operator identity information conforming to the allowed operator list.

8. The non-fungible token generating system of claim 7, wherein the sensing data comprises at least one of a fingerprint sensing data, a face recognition data, and a biometric data, or a combination thereof.

9. The non-fungible token generating system of claim 7, wherein the sensor is arranged in a second electronic device of the at least one electronic device, the non-fungible token generating operation and the multimedia data generating operation are executed by a first electronic device of the at least one electronic device, and the first electronic device has a communication connection with the second electronic device.

10. The non-fungible token generating system of claim 9, wherein the second electronic device is a mobile device, a head-mounted display, a handheld controller, or a wearable device.

11. A non-fungible token generating method, being adapted for use in at least one electronic device, wherein the non-fungible token generating method comprises following steps:
determining whether a control signal corresponds to a non-fungible token generating operation or a multimedia data generating operation;
executing the non-fungible token generating operation in response to the control signal corresponding to the non-fungible token generating operation, wherein the non-fungible token generating operation comprises:
generating a first multimedia data through an image capturing device; and
uploading, based on a smart contract deployed on a blockchain, the first multimedia data and an operator identity information to the blockchain to generate a non-fungible token corresponding to the first multimedia data, wherein the non-fungible token is stored in a first user account corresponding to the blockchain;
executing the multimedia data generating operation in response to the control signal corresponding to the multimedia data generating operation, wherein the multimedia data generating operation comprises:
generating a second multimedia data through the image capturing device; and
storing the second multimedia data in the at least one electronic device.

12. The non-fungible token generating method of claim 11, wherein the non-fungible token generating operation further comprises following steps:
executing a payment operation to pay an uploading fee corresponding to the blockchain based on a cryptocurrency wallet corresponding to a second user account; and
uploading, based on the smart contract deployed on the blockchain, the first multimedia data and the operator identity information to the blockchain to generate the non-fungible token corresponding to the first multimedia data in response to executing the payment operation.

13. The non-fungible token generating method of claim 11, wherein the non-fungible token generating operation and the multimedia data generating operation are executed by a first electronic device of the at least one electronic device, and the first electronic device and a second electronic device of the at least one electronic device have a communication connection.

14. The non-fungible token generating method of claim 13, wherein the control signal is generated by the second electronic device of the at least one electronic device.

15. The non-fungible token generating method of claim 11, wherein the non-fungible token corresponding to the first multimedia data comprises a metadata corresponding to the first multimedia data.

16. The non-fungible token generating method of claim 15, wherein the metadata corresponding to the first multimedia data is generated by following steps:
generating a contract address and a token identification of the metadata based on the smart contract deployed on the blockchain corresponding to the first user account.

17. The non-fungible token generating method of claim 11, wherein the non-fungible token generating operation further comprises following steps:
determining whether the operator identity information conforms to an allowed operator list corresponding to the at least one electronic device based on a sensing data, wherein the sensing data is generated by a sensor in the at least one electronic device; and
uploading, based on the smart contract deployed on the blockchain, the first multimedia data and an operator identity information to the blockchain to generate the non-fungible token corresponding to the first multimedia data in response to the operator identity information conforming to the allowed operator list.

18. The non-fungible token generating method of claim 17, wherein the sensing data comprises at least one of a fingerprint sensing data, a face recognition data, and a biometric data, or a combination thereof.

19. The non-fungible token generating method of claim 17, wherein the sensor is arranged in a second electronic device of the at least one electronic device, the non-fungible token generating operation and the multimedia data generating operation are executed by a first electronic device of the at least one electronic device, and the first electronic device has a communication connection with the second electronic device.

20. A non-transitory computer readable storage medium, having a computer program stored therein, wherein the computer program comprises a plurality of codes, the computer program executes a non-fungible token generating method after being loaded into at least one electronic device, wherein the non-fungible token generating method comprises following steps:
determining whether a control signal corresponds to a non-fungible token generating operation or a multimedia data generating operation;
executing the non-fungible token generating operation in response to the control signal corresponding to the non-fungible token generating operation, wherein the non-fungible token generating operation comprises:
generating a first multimedia data through an image capturing device; and
uploading, based on a smart contract deployed on a blockchain, the first multimedia data and an operator identity information to the blockchain to generate a non-fungible token corresponding to the first multimedia data, wherein the non-fungible token is stored in a first user account corresponding to the blockchain;
executing the multimedia data generating operation in response to the control signal corresponding to the multimedia data generating operation, wherein the multimedia data generating operation comprises:
generating a second multimedia data through the image capturing device; and
storing the second multimedia data in the at least one electronic device.
